(19) United States
(12) Patent Application Publication
(10) Pub. No.: US 2015/0088658 A1
(43) Pub. Date: Mar. 26, 2015

(54) ADVERTISEMENT DELIVER APPARATUS AND ADVERTISEMENT DELIVER METHOD

(71) Applicant: YAHOO JAPAN CORPORATION, Tokyo (JP)

(72) Inventors: Shouichi IIDUKA, Tokyo (JP); Nobuyuki AKASHI, Tokyo (JP); Hiroshi OTA, Tokyo (JP)

(21) Appl. No.: 14/332,707

(22) Filed: Jul. 16, 2014

(30) Foreign Application Priority Data
Sep. 20, 2013 (JP) 2013-195759

(51) Int. Cl. G06Q 30/02

(52) U.S. Cl. CPC G06Q 30/0267
USPC 705/14.64

(57) ABSTRACT

An advertisement delivery apparatus according to an embodiment includes a first advertising information output unit and a second advertising information output unit. The first advertising information output unit outputs first advertising information corresponding to user information on a company to the wireless terminal when the wireless terminal enters a site corresponding to the company. The second advertising information output unit outputs, to the wireless terminal, second advertising information corresponding to behavior of a user having the wireless terminal after the output of the first advertising information.

### CROSS-REFERENCE TO RELATED APPLICATIONS

The present application claims priority to and incorporates by reference the entire contents of Japanese Patent Application No. 2013-195759 filed in Japan on Sep. 20, 2013.

### BACKGROUND OF THE INVENTION

1. Field of the Invention

The present invention relates to an advertisement delivery apparatus and an advertisement delivery method.

2. Description of the Related Art

The recent remarkable spread of networks such as the Internet has led to active network-based deliveries of advertisements. As one mode of such deliveries of advertisements, targeted advertising is known whereby advertisements are delivered to specific users having user information that matches specific delivery conditions (e.g., attributes, interest, etc., of users) specified by an advertiser (see, for example, Japanese Patent Application Laid-open No. 2009-223423).

The known advertisement delivery techniques are, however, concerned with delivery of advertisements based on user information an advertisement delivery service provider has and the delivery often fails to represent the intention of the advertiser.

### SUMMARY OF THE INVENTION

An advertisement delivery apparatus according to an embodiment includes a company information database, an entry information acquiring unit, a user information extracting unit, a first advertising information output unit, and a second advertising information output unit. The company information database stores therein user information on a company. The entry information acquiring unit acquires entry information including information on a wireless terminal when the wireless terminal enters a site corresponding to the company. The user information extracting unit extracts, from the company information database, the user information on the company corresponding to an entry site of the wireless terminal based on the entry information. The first advertising information output unit outputs first advertising information corresponding to the user information extracted by the user information extracting unit to the wireless terminal. The second advertising information output unit outputs, to the wireless terminal, second advertising information corresponding to behavior of a user having the wireless terminal after the output of the first advertising information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are explanatory drawings illustrating an advertisement delivery process according to an embodiment of the present invention;

FIG. 2 is a diagram illustrating an exemplary specific configuration of an advertisement delivery system according to the embodiment;

FIG. 3 is a diagram illustrating an exemplary configuration of a wireless apparatus according to the embodiment;

FIGS. 4A and 4B are sequence diagrams for establishing a session between the wireless apparatus and a wireless terminal;

FIG. 5 is a diagram illustrating an exemplary configuration of an advertisement delivery apparatus according to the embodiment;

FIG. 6 is a diagram illustrating an exemplary partner company's user information table;

FIG. 7 is a diagram illustrating an exemplary advertising information table;

FIG. 8 is a diagram illustrating an exemplary terminal detection table;

FIG. 9 is a diagram illustrating an exemplary partner company information table;

FIG. 10 is a diagram illustrating an exemplary correspondence information table;

FIG. 11 is a diagram illustrating an exemplary advertisement delivery history table;

FIG. 12 is a diagram illustrating an exemplary behavior determining table;

FIG. 13 is a diagram illustrating an exemplary behavior history table;

FIG. 14 is a flowchart illustrating information processing performed by the wireless apparatus according to the embodiment;

FIG. 15 is a flowchart illustrating information processing performed by an advertisement delivery apparatus according to the embodiment;

FIG. 16 is a flowchart illustrating information processing performed in a first advertising information output process illustrated in FIG. 15; and

FIG. 17 is a hardware configuration diagram of an exemplary computer that achieves functions of the advertisement delivery apparatus.

### DETAILED DESCRIPTION OF THE PREFERRED EMBODIMENTS

An advertisement delivery apparatus, an advertisement delivery method, and an advertisement delivery program according to an embodiment of the present invention will be described in detail below with reference to the accompanying drawings. It is to be understood that the embodiment does not intend to limit the advertisement delivery apparatus, the advertisement delivery method, and the advertisement delivery program according to the present application. In the following, “database” will be abbreviated to “DB”.

1. Advertisement Delivery Process

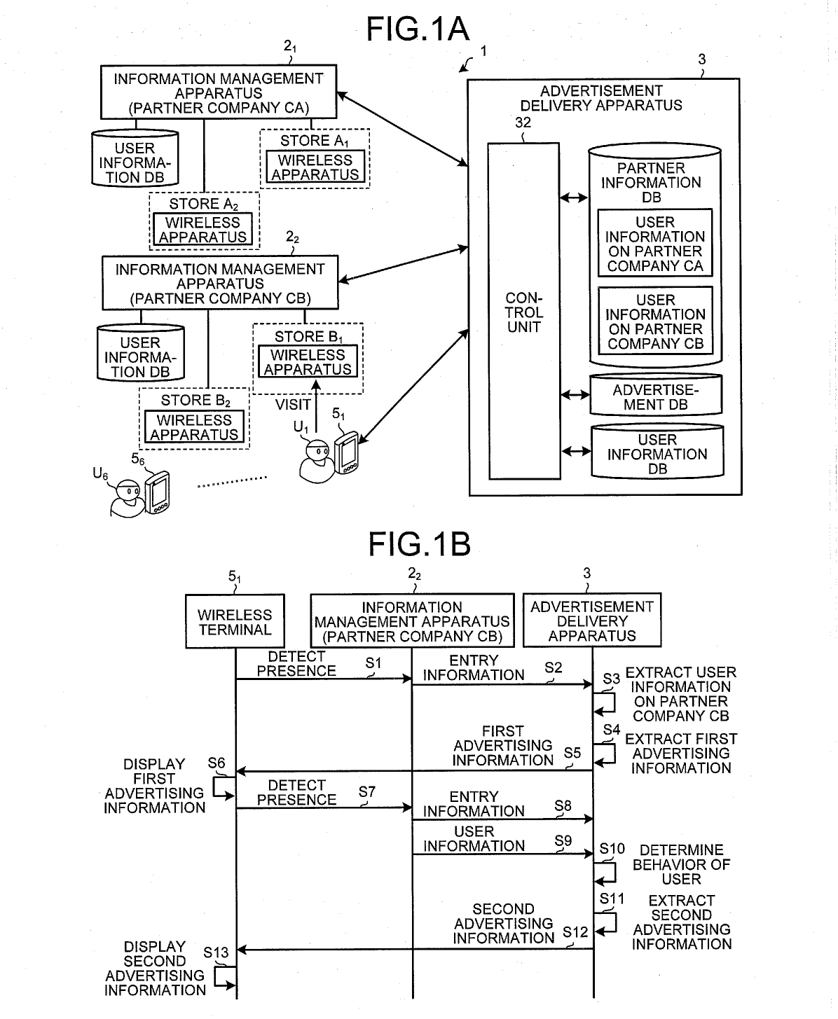

An advertisement delivery process according to the embodiment will first be described below. FIGS. 1A and 1B are explanatory drawings illustrating the advertisement delivery process according to the embodiment of the present invention. In the embodiment, the advertisement delivery process is performed by an advertisement delivery system.

1.1 Advertisement Delivery System

As illustrated in FIG. 1A, this advertisement delivery system 1 includes information management apparatuses 2₁, 2₂ and an advertisement delivery apparatus 3. The information management apparatuses 2₁, 2₂ (hereinafter also collectively referred to as an information management apparatus 2) are managed and operated by partner companies CA, CB (hereinafter also collectively referred to as a partner company C), respectively. The advertisement delivery apparatus 3 is managed and operated by an advertisement delivery service provider.

The partner company C is a company that has made a partnership agreement with the advertisement delivery service provider. The partner company C may, for example, be a distributor having a store that provides commodities or service. The partner company CA is a company that provides commodities or service at stores A₁, A₂. The partner company CB is a company that provides commodities or service at stores B₁, B₂. The partner company C may, for example, be, instead of the distributor, a performance show operator for concerts and sports events or a business operating a commercial space such as a hotel, a beauty parlor, a hospital, a movie theater, and a combined leisure facility.

The advertisement delivery system 1 provides wireless terminals 5₁ to 5₆ advertising information. The wireless terminals 5₁ to 5₆ are held by users U₁ to U₆ who visit a business place (hereinafter, “store”) such as a store or a facility of the partner company C or purchase a commodity or service at a store of the partner company C. In the following, the wireless terminals 5₁ to 5₆ may be collectively referred to as a wireless terminal 5 and the users U₁ to U₆ may be collectively referred to as a user U.

The wireless terminal 5 may, for example, be a smartphone, a mobile personal computer (PC), or any other portable wireless terminal. The wireless terminal 5 can communicate with the advertisement delivery apparatus 3 connected to a communication network (e.g., the Internet) over, for example, a wireless local area network (LAN) or portable telephone communication.

The information management apparatus 2₁ has a user information DB that stores therein user information owned by the partner company CA. The information management apparatus 2₂ has a user information DB that stores therein user information owned by the partner company CB. The advertisement delivery apparatus 3 acquires the user information owned by the partner companies CA, CB from the information management apparatuses 2₁, 2₂ and stores the acquired user information in a partner information DB (an exemplary company information DB).

Types of the user information stored in the user information DB include information on histories of visits and purchases made by the user U at a store of the partner company C (hereinafter also referred to as behavior history information) and identification information on the wireless terminal 5 (hereinafter, terminal ID). The behavior history information includes, for example, identification information for stores of the partner company C (hereinafter, store ID).

Each of the stores of the partner company C has at least one wireless LAN communication apparatus (hereinafter, wireless apparatus) installed therein. The wireless apparatus covers a wireless communication area within the store. The wireless communication area of the wireless apparatus includes, for example, areas (hereinafter, store area) within and surrounding the store. The wireless apparatus detects a wireless signal of the wireless terminal 5 of the user U (hereinafter also referred to as entry user U) who enters the store of the partner company C, thereby detecting an entry of the wireless terminal 5 in the store area. The information management apparatus 2 transmits to the advertisement delivery apparatus 3 entry information that includes information on the wireless terminal 5 detected by the wireless apparatus as a result of its entry in the store area.

A control unit 32 of the advertisement delivery apparatus 3, having received the entry information from the information management apparatus 2, extracts, from the partner information DB, user information on the partner company C corresponding to an entry site of the user U and provides the wireless terminal 5 of the entry user U with advertising information corresponding to the extracted user information.

After having provided the wireless terminal 5 of the entry user U with the advertising information (hereinafter also referred to as first advertising information), the advertisement delivery apparatus 3 outputs, to the wireless terminal 5 of the entry user U, advertising information corresponding to behavior exhibited thereafter by the entry user U (hereinafter also referred to as second advertising information). In this manner, the advertisement delivery system 1 provides the entry user U with the second advertising information that corresponds to the behavior of the entry user U who has previously been provided with the first advertising information. This efficiently improves an advertising effect by the second advertising information.

1.2 Exemplary Advertisement Delivery Process

The following describes, with reference to FIG. 1B, an exemplary advertisement delivery process performed when the user U₁ of the wireless terminal 5₁ enters the store area of the store B.

When the user U₁ of the wireless terminal 5₁ enters the store area of the store B₁, the wireless apparatus installed in the store B₁ detects a wireless signal output from the wireless terminal 5₁ to thereby detect the wireless terminal 5₁. The wireless apparatus notifies the information management apparatus 2₂ of the terminal ID assigned to the detected wireless terminal 5₁. The information management apparatus 2₂ thereby detects presence of the wireless terminal 5₁ in the store area of the store B₁ (Step S1).

The information management apparatus 2₂ transmits to the advertisement delivery apparatus 3 entry information that includes the terminal ID of the wireless terminal 5₁ acquired from the wireless apparatus, the store ID of the store B₁, and identification information on the partner company CB (hereinafter, company ID) (Step S2). The entry information may, instead, be transmitted directly from the wireless apparatus installed in the store B₁ to the advertisement delivery apparatus 3.

The control unit 32 of the advertisement delivery apparatus 3 extracts user information from the partner information DB based on the entry information transmitted from the information management apparatus 2₂ or the wireless apparatus (Step S3). For example, the control unit 32 extracts, from the partner information DB, out of the user information on the partner company CB associated with the company ID included in the entry information, user information on the user U₁ associated with the terminal ID included in the entry information.

Alternatively, the control unit 32 may extract, as the user information extracted from the partner information DB, the user information on the user U₁ from the user information corresponding to the store B₁ of the partner company CB based on the company ID and the store ID.

The control unit 32 extracts, from an advertisement DB, advertising information corresponding to the user information extracted from the partner information DB as the first advertising information (Step S4), and transmits the extracted first advertising information to the wireless terminal 5₁ of the entry user U₁ (Step S5). The control unit 32 transmits the first advertising information to the wireless terminal 5₁ via the wireless apparatus installed in the store B₁ or a portable telephone communication network.

A control unit of the wireless terminal 5₁ displays the first advertising information acquired from the advertisement delivery apparatus 3 on a display of the wireless terminal 5₁ (Step S6). In this manner, the advertisement delivery apparatus 3 can provide the wireless terminal 5₁ of the entry user U₁ with the advertising information related to the partner company CB.

For example, an advertiser submits advertising information with delivery conditions that specify the partner company CB and a user attribute (e.g., an interest of the user U) to thereby be able to deliver the advertising information to the wireless terminal 5 of the user U having the specified user information out of the users U who use the partner company C. The advertiser may further include specification of a store in the delivery conditions to thereby deliver the advertising information to the wireless terminal 5 of the user U having the user information corresponding to the specified store.

If, for example, a manufacturer that provides commodities displayed in a store of the partner company C submits advertising information as an advertiser to the advertisement delivery apparatus 3, the advertising information can be delivered specifically to the user U of the partner company C. This enables the purchase of commodities and services to be promoted more effectively and with higher accuracy. Furthermore, the user information on the partner company C includes a purchase history of the commodities provided by the manufacturer. Therefore, for example, advertising information can be delivered specifically to the user U who has purchased a commodity targeted by the advertising information. This enables the purchase of commodities and services to be promoted more effectively and with higher accuracy.

The entry user U₁ provided with the first advertising information in the store area of the store B₁ behaves differently according to various factors including a character, a taste, and living conditions. For example, the entry user U₁ may purchase a commodity or service according to the first advertising information or simply pass by the area around the store B₁. Alternatively, the entry user U₁ may hesitate over purchasing a commodity or service according to the first advertising information or linger in the store B₁ with a purpose different from the purchase of commodities or service.

Thus, the control unit 32 of the advertisement delivery apparatus 3, after having provided the first advertising information, provides the wireless terminal 5 of the entry user U with the second advertising information according to the behavior of the entry user U. This efficiently improves an advertising effect by the advertising information.

After the first advertising information has been transmitted from the advertisement delivery apparatus 3 to the wireless terminal 5₁ at Step S5, the control unit 32 of the advertisement delivery apparatus 3 acquires from the information management apparatus 2₂ the entry information and user information that has been updated (hereinafter also referred to as updated user information) (Steps S8, S9). Similarly to Step S1, the entry information is transmitted from the information management apparatus 2₂ or the wireless apparatus by the detection of presence of the wireless terminal 5₁ (Step S7).

Based on the entry information and the updated user information, the control unit 32 of the advertisement delivery apparatus 3 determines behavior of the entry user U₁ after the first advertising information has been provided (Step S10). The control unit 32 determines the behavior of the entry user U₁ based on, for example, a time period of stay or a moving state of the entry user U₁ in the store area of the store B₁ and whether the entry user U₁ has purchased a commodity or service at the store B₁ and a specific commodity or service the entry user U₁ has purchased.

The control unit 32 extracts, from the advertisement DB, the advertising information corresponding to the behavior of the entry user U₁ as the second advertising information (Step S11), and transmits the extracted second advertising information to the wireless terminal 5₁ of the entry user U₁ (Step S12). The control unit of the wireless terminal 5₁ displays the second advertising information acquired from the advertisement delivery apparatus 3 on the display of the wireless terminal 5₁ (Step S13).

When determining, for example, that the entry user U₁ has purchased a commodity or service as an advertising object of the first advertising information at the store B₁, the control unit 32 transmits a coupon of the purchased commodity or service as the second advertising information to the wireless terminal 5₁. This can motivate the entry user U₁ to purchase the purchased commodity or service repeatedly.

When determining, for example, that the entry user U₁ walks around in the store B₁, the control unit 32 transmits, as the second advertising information, advertising information on a type of commodity or service different from the type of commodity or service as the advertising object of the first advertising information to the wireless terminal 5₁. This can enhance a probability of purchase of a commodity or service in the store B₁ by the entry user U₁.

As described above, by providing the second advertising information based on the behavior of the entry user U after having provided the wireless terminal 5 of the entry user U with the first advertising information related to the partner company C, the advertisement delivery apparatus 3 can promote the purchase of commodities and services to be more effectively and with higher accuracy.

2. Details of Advertisement Delivery System 1

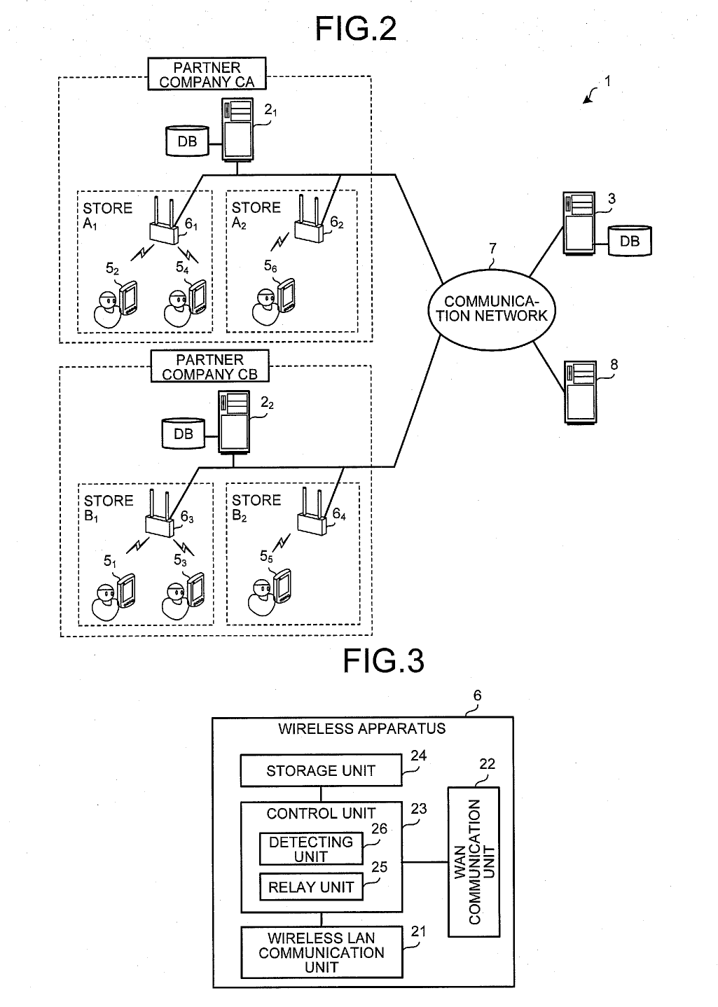

The following describes an exemplary configuration of the advertisement delivery system 1 according to the embodiment with reference to FIG. 2. FIG. 2 is a diagram illustrating an exemplary configuration of the advertisement delivery system 1 according to the embodiment.

As illustrated in FIG. 2, the advertisement delivery system 1 includes the information management apparatuses 2₁, 2₂, the advertisement delivery apparatus 3, the wireless terminals 5₁ to 5₆, wireless apparatuses 6₁ to 6₄ (hereinafter also collectively referred to as a wireless apparatus 6), and a server 8.

The information management apparatus 2, the advertisement delivery apparatus 3, the wireless apparatus 6, and the server 8 are connected to one another so as to be mutually communicable via a communication network 7. The communication network 7 is, for example, a wide area network (WAN) such as the Internet.

The example illustrated in FIG. 2 exemplarily includes the two partner companies CA, CB; however, the number of partner companies C may be one, or three or more. At least one wireless apparatus 6 is installed in each of the stores of the partner company C. In the example illustrated in FIG. 2, the wireless apparatuses 6₁, 6₂ are installed in the stores A₁, A₂, respectively, of the partner company CA and the wireless apparatuses 6₃, 6₄ are installed in the stores B₁, B₂, respectively, of the partner company CB.

The information management apparatus 2 has the user information DB that stores therein user information on the partner company C associated therewith. The user information stored in the user information DB includes, for example, the behavior history information for each terminal ID, updated by a control unit of the information management apparatus 2 for each visit or purchase by the user U. The control unit of the information management apparatus 2 transmits the updated user information to the advertisement delivery apparatus 3.

The wireless terminal 5 has, for example, a wireless LAN communication function similarly to a smartphone or a mobile PC, capable of communicating with the wireless apparatus 6 or a wireless WAN base station (not illustrated). It is noted that the wireless WAN base station is, for example, a portable telephone base station of a portable telephone communication network and is connected to the communication network 7.

The wireless apparatus 6 is, for example, a wireless LAN access point. If the wireless terminal 5 can transmit a terminal ID through near field communication (NFC), however, the wireless apparatus 6 may be an NFC apparatus. The NFC covers a communication area extending over about one meter to several centimeters. Examples of the NFC include Felica and ISO/IEC14443 (MIDARE). Communication by the NFC is not limited only to radio waves. Alternatively, for example, infrared rays, visible rays, and sound waves may be used.

The server 8 is managed and operated by the advertisement delivery service provider. In response to access from the wireless terminal 5 over the communication network 7, the server 8 provides the wireless terminal 5 with, for example, various categories of web pages via the communication network 7.

A configuration of the wireless apparatus 6 will first be described below, followed by a description of a configuration of the advertisement delivery apparatus 3.

2.1 Configuration of Wireless Apparatus 6

The configuration of the wireless apparatus 6 will be described in detail below. FIG. 3 is a diagram illustrating an exemplary configuration of the wireless apparatus 6. As illustrated in FIG. 3, the wireless apparatus 6 is a wireless LAN access point and includes a wireless LAN communication unit 21, a WAN communication unit 22, a control unit 23, and a storage unit 24.

The wireless LAN communication unit 21 is disposed such that a site corresponding to the partner company C (e.g., within a store of the partner company C or an area therearound) is covered by a wireless communication area thereof (hereinafter, AP communication area). The wireless LAN communication unit 21 is a communication interface that performs wireless LAN communication, transmitting and receiving information to and from the wireless terminal 5 on which a wireless LAN communication function is mounted. The wireless LAN may, for example, be one specified by IEEE802.11. The wireless LAN compatible with the foregoing standard is not, however, the only possible choice.

The WAN communication unit 22 is connected to the communication network 7 and transmits and receives information to and from the information management apparatus 2 and the advertisement delivery apparatus 3 over the communication network 7. The connection between the WAN communication unit 22 and the communication network 7 may be hard-wired or wireless.

The control unit 23 includes a relay unit 25 that relays information and a detecting unit 26 that detects the wireless terminal 5. The control unit 23 performs the information processing functions and effects to be described below. Additionally, the control unit 23 is achieved by an integrated circuit, such as an application specific integrated circuit (ASIC) and a field programmable gate array (FPGA).

The control unit 23 functions as the relay unit 25 and the detecting unit 26 when an internal central processing unit (CPU) or micro processing unit (MPU) performs a computer program stored in an internal storage using a RAM as a work space. It is noted that the internal configuration of the control unit 23 described above is not the only one possibility, and the control unit 23 may be configured otherwise as long as the control unit 23 can perform information processing to be described later.

The relay unit 25, for example, transmits information acquired from the wireless terminal 5 via the wireless LAN communication unit 21, from the WAN communication unit 22 to the server 8 or the advertisement delivery apparatus 3. The relay unit 25 also transmits information acquired from the server 8 or the advertisement delivery apparatus 3 via the WAN communication unit 22, from the wireless LAN communication unit 21 to the wireless terminal 5.

Transmission of information from the wireless apparatus 6 to the server 8 or the advertisement delivery apparatus 3 is performed, for example, through packet communication that defines an address of the communication network 7 assigned to the wireless apparatus 6 as a transmitter address and an address of the communication network 7 assigned to the server 8 or the advertisement delivery apparatus 3 as a receiver address. The address of the communication network 7 is, for example, an address assigned to the WAN communication unit 22.

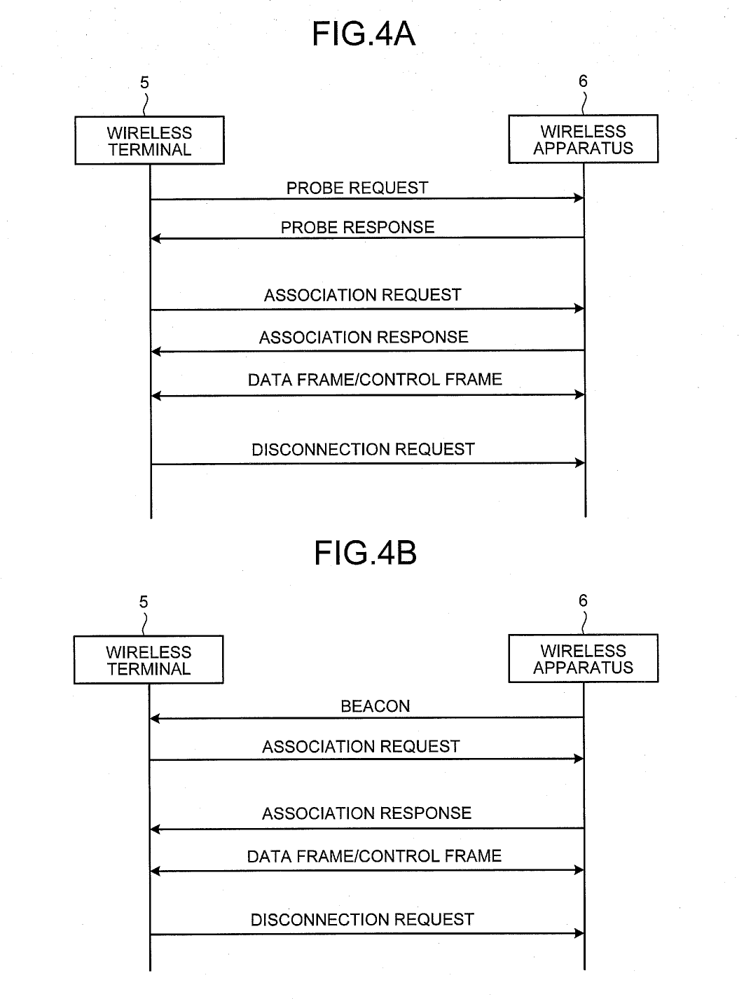

The detecting unit 26 acquires via the wireless LAN communication unit 21 information on a wireless packet (an exemplary wireless signal) transmitted from the wireless terminal 5 to thereby detect presence of the wireless terminal 5. FIGS. 4A and 4B are exemplary sequence diagrams for establishing a session between the wireless apparatus 6 and the wireless terminal 5. The sequence for establishing the session is not limited only to the examples illustrated in FIGS. 4A and 4B.

The example illustrated in FIG. 4A illustrates that a wireless packet called a probe request is transmitted by broadcast or the like from the wireless terminal 5 at regular intervals. The detecting unit 26 acquires information on the wireless packet via the wireless LAN communication unit 21 to thereby detect presence of the wireless terminal 5.

The probe request includes a service set identifier (SSID). If the SSID included in the probe request matches an SSID of the wireless LAN communication unit 21, the detecting unit 26 transmits a probe response to the wireless terminal 5. When receiving the probe response, the wireless terminal 5 shifts into a communication state, if automatic communication has been set. The shift into the communication state is achieved by establishing a session using an association request and an association response as illustrated in FIG. 4A. Thereafter, a data frame and a control frame are transmitted or received between the wireless terminal 5 and the wireless LAN communication unit 21 to thereby cause the communication state to be started.

Additionally, the detecting unit 26 broadcasts via the wireless LAN communication unit 21 a wireless packet called a beacon, as illustrated in FIG. 4B, to the wireless terminal 5 to which the wireless packet is not transmitted at regular intervals. On receipt of an association request relative to the beacon, the detecting unit 26 detects presence of the wireless terminal 5. The detecting unit 26, having received the association request, transmits an association response to the wireless terminal 5 to thereby establish a session in which the wireless terminal 5 and the wireless LAN communication unit 21 are communicating with each other.

The communication state is canceled when a disconnection request is received or when a wireless packet cannot be transmitted or received between the wireless terminal 5 and the wireless LAN communication unit 21. The detecting unit 26 repeatedly receives wireless packets to thereby detect presence of the wireless terminal 5 until the communication state is canceled.

The detecting unit 26, when, for example, determining that the wireless terminal 5 has been detected, transmits the entry information to the advertisement delivery apparatus 3 via the WAN communication unit 22 and the communication network 7. Specifically, the detecting unit 26 extracts the terminal ID included in the wireless packet transmitted from the wireless terminal 5 and further detects radio wave strength.

The terminal ID is, for example, a MAC address of a wireless LAN communication unit of the wireless terminal 5 and transmitted from the wireless terminal 5 by being appended to the wireless packet. The radio wave strength represents that of the wireless signal received by the wireless apparatus 6. It is noted that the radio wave strength may be received signal strength indication (RSSI) acquired in the wireless terminal 5. In this case, a wireless signal including information on the radio wave strength is transmitted from the wireless terminal 5 to the wireless apparatus 6.

The detecting unit 26 transmits, in addition to the terminal ID of the wireless terminal 5 and the radio wave strength information, information including the company ID and the store ID as entry information to the advertisement delivery apparatus 3 at regular intervals (e.g., every one second). The store ID is identification information for the store in which the wireless apparatus 6 is installed. A network address of the communication network 7 assigned to the WAN communication unit 22 may, for example, be used as the store ID. It is noted that the store ID does not necessarily have to be a network address as long as the store can be identified by the store ID. Additionally, the entry information may be arranged to be transmitted to the advertisement delivery apparatus 3 via the information management apparatus 2.

2.2 Advertisement Delivery Apparatus 3

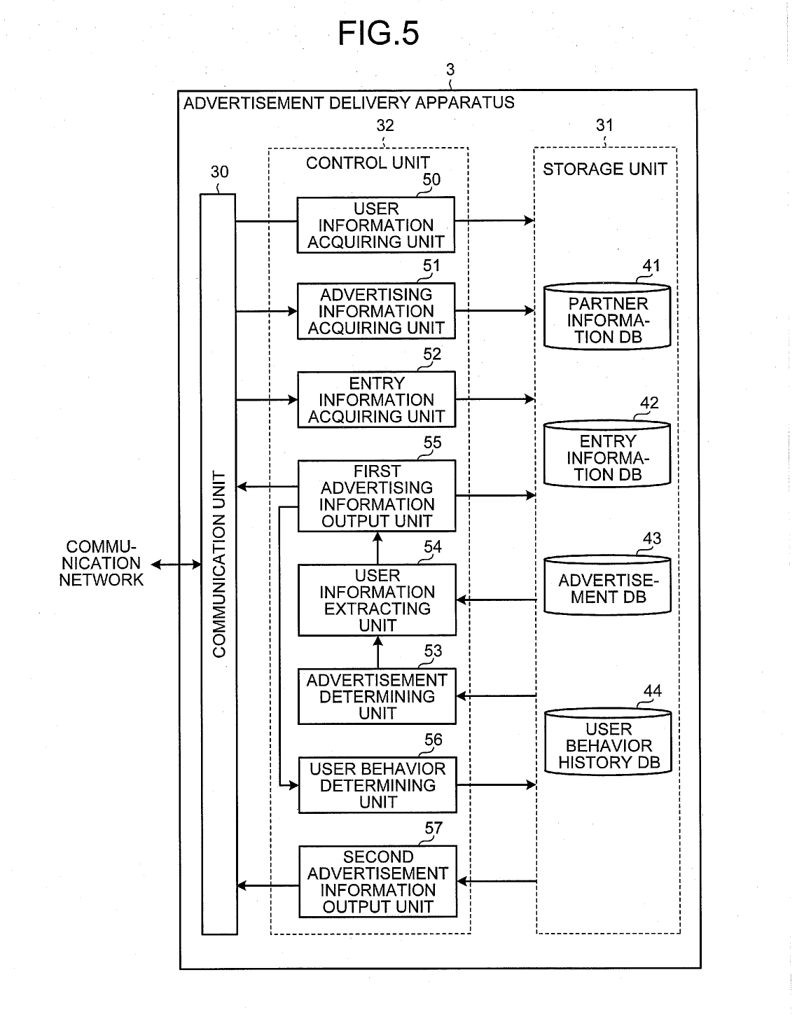

The configuration of the advertisement delivery apparatus 3 will be described in detail below. FIG. 5 is a diagram illustrating an exemplary configuration of the advertisement delivery apparatus 3. As illustrated in FIG. 5, the advertisement delivery apparatus 3 includes a communication unit 30, a storage unit 31, and the control unit 32.

The communication unit 30 is an interface such as a network interface card (NIC). The control unit 32 can transmit and receive various types of information to and from the information management apparatus 2, the wireless terminal 5, the wireless apparatus 6, and the server 8 via the communication unit 30 and the communication network 7.

The storage unit 31 includes a partner information DB 41 (an exemplary company information DB), an entry information DB 42, an advertisement DB 43, and a user behavior history DB 44. The control unit 32 includes a user information acquiring unit 50, an advertising information acquiring unit 51, an entry information acquiring unit 52, an advertisement determining unit 53, a user information extracting unit 54, a first advertising information output unit 55, a user behavior determining unit 56, and a second advertising information output unit 57. The configuration of the control unit 32 described above is not the only one possibility, and the control unit 32 may be configured otherwise as long as the configuration enables information processing to be described later to be performed.

2.2.1 User Information Acquiring Unit 50

The user information acquiring unit 50 acquires from the information management apparatuses 2₁, 2₂ user information owned by each of the partner companies CA, CB and stores the user information in the partner information DB 41. The user information is updated on a real-time basis or at regular intervals in each partner company C and the user information acquiring unit 50 acquires the updated user information to thereby update the user information in the partner information DB 41.

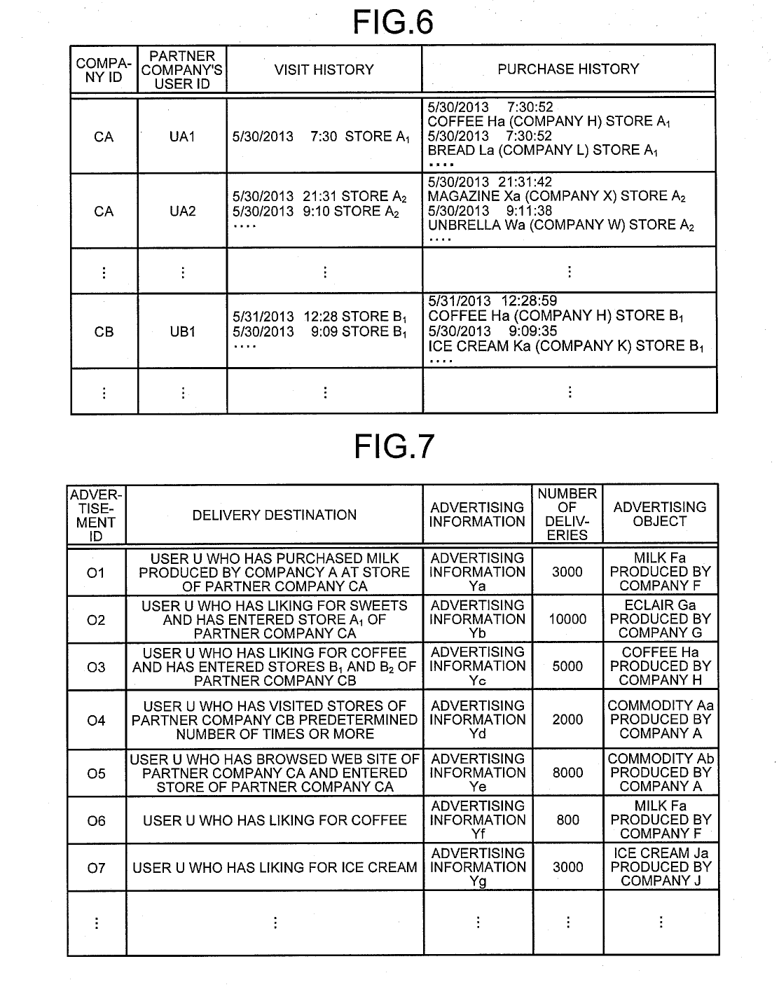

FIG. 6 is a diagram illustrating an exemplary partner company's user information table stored in the partner information DB 41. As illustrated in FIG. 6, the partner company's user information table provides information on the behavior history information such as “company ID”, “partner company's user ID”, “visit history”, and “purchase history”, each being associated with each other.

The “company ID” is identification information for the partner company C. In the example illustrated in FIG. 6, “CA” is the company ID of the partner company CA and “CB” is the company ID of the partner company CB. It is noted that, although the example illustrated in FIG. 6 sets both the user information on the partner company CA and the user information on the partner company CB on the same partner company's user information table, management of the user information on the partner company C is not limited only to such a configuration.

For example, one partner company's user information table may be set for each partner company C, so that the user information can be set on the partner company's user information table corresponding to each partner company C. A partner information DB may even be set for each partner company C. This allows the user information to be managed for each partner company C.

The “partner company's user ID” is a user ID unique to each partner company C and assigned to the user U who uses the partner company C. In the example illustrated in FIG. 6, “UA1”, “UA2”, and the like are assigned in the partner company CA and “UB1” and the like are assigned in the partner company CB. It is noted that the set of the company ID and the partner company's user ID only needs to be unique information, and the partner company's user ID of the partner company CA and the partner company's user ID of the partner company CB may be duplicated.

The “visit history” is a history of visits made by the user U relative to, for example, a store of the partner company C. For example, as illustrated in FIG. 6, the “visit history” includes information such as the date and time of day of the visit and a specific store visited by the user U. The “purchase history” is a history of purchases made by the user U at the store of the partner company C. For example, as illustrated in FIG. 6, the “purchase history” includes information such as the date and time of day of the purchase made, a specific commodity the user U purchased (including a manufacturer name and a commodity name), and a specific store at which the user U purchased the commodity.

The types of user information on the partner company C are not limited only to those illustrated in FIG. 6. For example, age, sex, favorite items, visit frequency, and an average value of purchases may constitute the information. Each partner company C may even set unique types of information for the user information.

Still alternatively, the user information acquiring unit 50 may, for example, acquire a browsing history of a web site from the information management apparatus 2 and set the partner company's user information table as the user information for the corresponding partner company C.

2.2.2 Advertising Information Acquiring Unit 51

The advertising information acquiring unit 51 acquires submission information including the advertising information from a terminal apparatus of the advertiser via the communication network 7 and sets the submission information on an information table of the advertisement DB 43. FIG. 7 is a diagram illustrating an exemplary advertising information table.

As illustrated in FIG. 7, the advertising information table includes information on “delivery destination”, “advertising information”, “number of deliveries”, and “advertising object” associated with “advertisement ID”. The “advertisement ID” is identification information assigned by the user information acquiring unit 50 to each of received delivery requests. The “delivery destination” represents conditions for the delivery destination specified by the delivery request. At least one delivery destination condition can be set.

The “advertising information” is advertising information on the object to be delivered, including a text advertisement, a still image advertisement, a moving image advertisement, an animation advertisement, and a banner advertisement. The advertising information includes not only image material and program codes for advertisement display, but also data including link information for acquiring the image material and program codes. The “number of deliveries” is the number of deliveries to be made for the advertising information specified by the delivery request. The “advertising object” is the object of the advertising information. For example, “advertising information Ya” is advertising information having “milk Fa produced by company F” as the advertising object. It is noted that the advertising information table includes the delivery conditions such as a delivery period specified by the delivery request and information on the commodity or service as the advertising object and on the advertiser. The example illustrated in FIG. 7, however, omits these pieces of information.

In addition, as illustrated in FIG. 7, the advertising information table allows the following to be set as conditions for the “delivery destination”. Specifically, the conditions may, for example, be such that: the user U has a liking for a specific commodity and enters a store of the partner company C; the user U has purchased a specific commodity at a store of the partner company C; and the user U has visited a specific store of the partner company C a predetermined number of times or more. Additionally, the advertising information table also allows the user U who has browsed the web site of the partner company C to be set as the “delivery destination”.

2.2.3 Entry Information Acquiring Unit 52

The entry information acquiring unit 52 acquires entry information from the wireless apparatus 6 that covers a site corresponding to the partner company C as the AP communication area. If the entry information is transmitted from the wireless apparatus 6 via the information management apparatus 2, the entry information acquiring unit 52 may acquire the entry information from the information management apparatus 2.

The entry information acquiring unit 52 updates a terminal detection table in the entry information DE 42 based on the company ID, the store ID, the terminal ID, and the radio wave strength information included in the entry information.

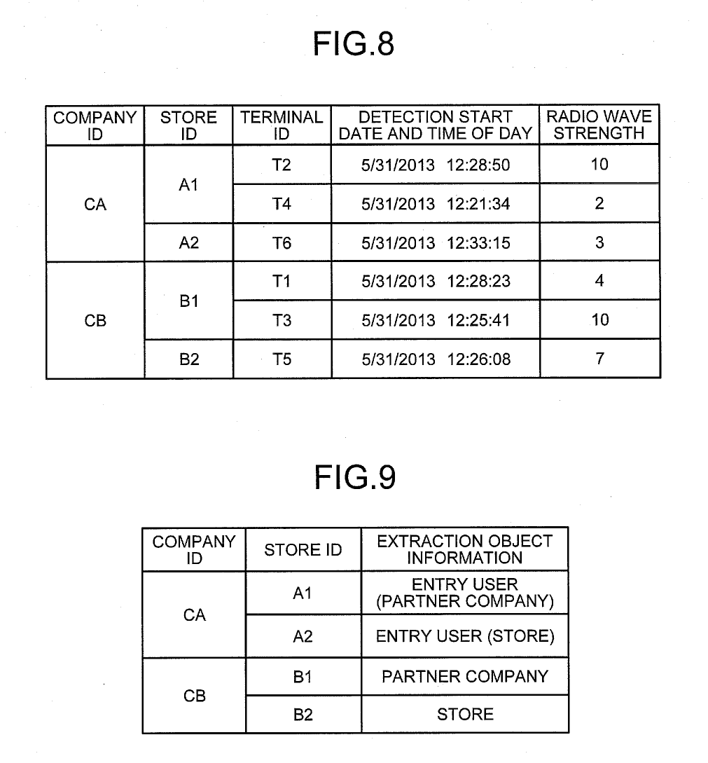

FIG. 8 is a diagram illustrating an exemplary terminal detection table. As illustrated in FIG. 8, the terminal detection table includes information on “company ID”, “store ID”, “terminal ID”, “detection start date and time of day”, and “radio wave strength”, each being associated with each other. The “company ID” is identification information for the partner company C. The “store ID” is identification information for the store in which the wireless apparatus 6 is installed. The “store ID” may, for example, be a network address of the wireless apparatus 6. The “terminal ID” is identification information for the wireless terminal 5 detected by the wireless apparatus 6. The “terminal ID” may, for example, be a MAC address of the wireless LAN communication unit of the wireless terminal 5.

The “detection start date and time of day” represents the time of day at which the wireless terminal 5 is detected in the AP communication area (detection start time of day). The “radio wave strength” is the radio wave strength of the wireless packet of the wireless terminal 5 detected by the wireless apparatus 6. The “radio wave strength” may, for example, be average radio wave strength since the detection start time of day.

2.2.4 Advertisement Determining Unit 53

The advertisement determining unit 53 determines, based on the entry information set in the terminal detection table in the entry information DB 42, whether the wireless terminal 5 that has entered a site corresponding to the partner company C is an advertising object.

The advertisement determining unit 53 determines the wireless terminal 5 that has entered the site corresponding to the partner company C to be the advertising object, if the time period of stay and the radio wave strength of the wireless terminal 5 present in the AP communication area satisfy previously set determining conditions based on the terminal detection table in the entry information DB 42.

For example, the advertisement determining unit 53 determines a wireless terminal 5 to be the advertising object, if, with respect to the wireless terminal 5, the time period of stay in the AP communication area is equal to, or longer than, a time threshold value and the radio wave strength is equal to, or greater than, a strength threshold value. In contrast, if, relative to a wireless terminal 5, for example, the time period of stay in the AP communication area is less than the time threshold value and the radio wave strength is less than the strength threshold value, the advertisement determining unit 53 does not determine the wireless terminal 5 to be the advertising object.

The advertisement determining unit 53 can detect the time period of stay of the wireless terminal 5 within the AP communication area by comparing the detection start time of day set in the terminal detection table with the current time of day.

The advertisement determining unit 53, when determining that the wireless terminal 5 has entered the site corresponding to the partner company C, notifies the user information extracting unit 54 of an information extraction instruction. The information extraction instruction includes the company ID, the store ID, and the terminal ID.

The threshold value information including the time threshold value and the strength threshold value described above can be adjusted for each store ID or terminal ID. For example, the setting values of the threshold value information for each store can be transmitted from the information management apparatus 2 or a terminal apparatus (not illustrated) or the wireless terminal 5 to the advertisement delivery apparatus 3, so that the advertisement determining unit 53 stores the threshold value information acquired via the communication unit 30 in the entry information DB 42.

2.2.5 User Information Extracting Unit 54

The user information extracting unit 54, when notified of an information extraction instruction by the advertisement determining unit 53, extracts user information from the partner information DB 41 based on the terminal ID of the wireless terminal 5 included in the information extraction instruction.

Specifically, the user information extracting unit 54 identifies extraction object information based on the company ID and the store ID including in the information extraction instruction. The extraction object information is identified based on a partner company information table stored in the partner information DB 41.

FIG. 9 is a diagram illustrating an exemplary partner company information table. As illustrated in FIG. 9, the partner company information table includes information on “store ID” and “extraction object information” associated with “company ID”. The extraction object information is set in the partner company information table by the user information acquiring unit 50 in response to, for example, a request made from an apparatus of the partner company C (e.g., the information management apparatuses 2₁, 2₂).

In the example illustrated in FIG. 9, “entry user (partner company)” is associated as the “extraction object information” with the store ID “A1”, “entry user (store)” is associated as the “extraction object information” with the store ID “A2”, “partner company” is associated as the “extraction object information” with the store ID “B1”, and “store” is associated as the “extraction object information” with the store ID “B2”.

The “entry user (partner company)” is the setting for extracting “of the user information on the entry user U, user information on the partner company C which the entry user U has entered”. The “entry user (store)” is the setting for extracting “of the user information on the entry user U, user information on the store which the entry user U has entered”. The “partner company” is the setting for extracting “all user information on the partner company C which the entry user U has entered”. The “store” is the setting for extracting “all user information on the store which the entry user U has entered”.

If the extraction object information associated with the company ID and the store ID is “entry user (partner company)” or “entry user (store)”, the user information extracting unit 54 identifies the user ID of the partner company C (partner company's user ID) corresponding to the site which the wireless terminal 5 has entered based on the terminal ID included in the information extraction instruction. The identification is performed based on a correspondence information table stored in the advertisement DB 43.

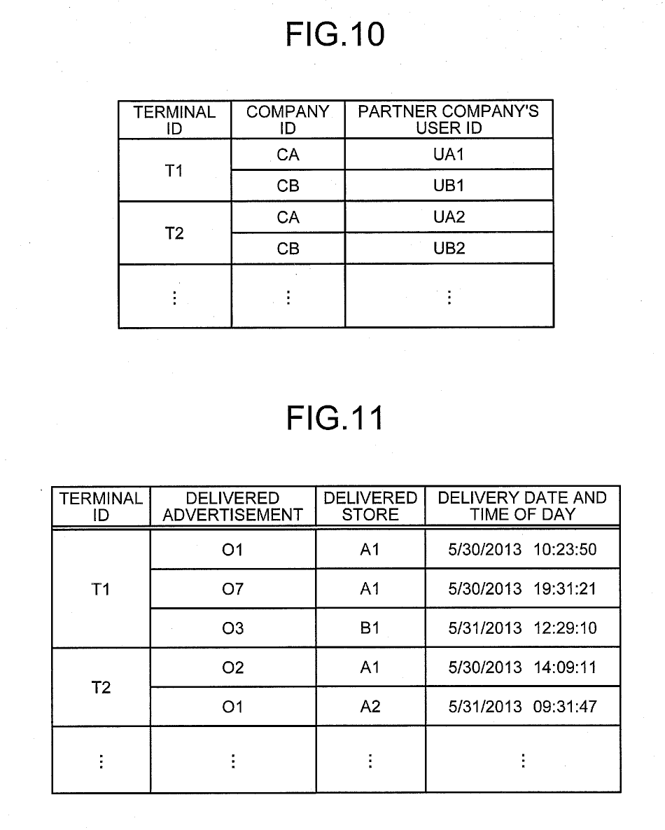

FIG. 10 is a diagram illustrating an exemplary correspondence information table. As illustrated in FIG. 10, the correspondence information table includes information on “company ID” and “partner company's user ID” associated with each “terminal ID”. If, for example, the information extraction instruction includes the terminal ID “T1” and the company ID “CA”, the user information extracting unit 54 determines the partner company's user ID to be “UA1”.

Having identified the extraction object information and the partner company's user ID based on the information extraction instruction, the user information extracting unit 54 extracts user information from the partner information DB 41. Specifically, if the company ID is “CA”, the extraction object information is “entry user (partner company)”, and the partner company's user ID is “UA1”, the user information extracting unit 54 extracts, of the user information on the partner company CA, user information with the partner company's user ID “UA1” from the partner company's user information table.

If the company ID is “CA”, the store ID is “A1”, the extraction object information is “entry user (store)”, and the partner company's user ID is “UA1”, the user information extracting unit 54 extracts, of the user information on the partner company CA, user information associated with the partner company's user ID “UA1” and including information on “store A₁” from the partner company's user information table.

If the company ID is “CA” and the extraction object information is “partner company”, the user information extracting unit 54 extracts all user information on the partner company CA from the partner company's user information table. If the company ID is “CA”, the store ID is “A1”, and the extraction object information is “store”, the user information extracting unit 54 extracts, of the user information on the partner company CA, user information including information on “store A₁” from the partner company's user information table.

As described above, the user information extracting unit 54 extracts the user information on the partner company C corresponding to the site which the wireless terminal 5 has entered, but not user information on any of those other than the partner company C corresponding to the site which the wireless terminal 5 has entered. Thus, access limit is imposed on user information in units of the partner company C, which can ensure security in units of the partner company C.

Having extracted the user information on the partner company C corresponding to the site which the wireless terminal 5 has entered, the user information extracting unit 54 appends as additional information the partner company's user ID of the entry user U and the company ID and the store ID corresponding to the entry site to the user information and notifies the first advertising information output unit 55 of the user information. Assume a case, for example, in which the user U₁ of the wireless terminal 5₁ with the terminal ID “T1” enters the store A₁ of the partner company CA. In this case, the provider user ID “U1”, the company ID “CA”, and the store ID “A1” are appended as additional information to the user information on the company ID “CA” and the user information appended with the additional information is notified to the first advertising information output unit 55. Alternatively, the additional information included in the user information extracted from the partner information DB 41 may be notified to the first advertising information output unit 55.

2.2.6 First Advertising Information Output Unit 55

The first advertising information output unit 55 extracts, from the advertising information table of the advertisement DB 43, advertising information corresponding to the information notified from the user information extracting unit 54 and outputs the advertising information to the wireless terminal 5 as the delivery object.

Assume, for example, a case in which the partner company's user information table is as illustrated in FIG. 6 and the advertising information table is as illustrated in FIG. 7. If the user information notified from the user information extracting unit 54 is that of the partner company's user ID “UA1”, the first advertising information output unit 55 extracts, for example, the “advertising information Yf” with the advertisement ID “O6” from the advertising information table, because the user information includes a purchase history of “coffee Ha (company H)”.

Assume, for example, another case in which the entry user U has a liking for “sweets” as identified from the purchase history of the user information and the company ID and the store ID included in the additional information are “CA” and “A1”, respectively. In this case, the first advertising information output unit 55 extracts, for example, the “advertising information Yb” with the advertisement ID “O2” from the advertising information table.

Assume, for example, still another case in which the entry user U has a liking for “coffee” as identified from the purchase history of the user information and the company ID and the store ID included in the additional information are “CB” and “B1” or “B2”, respectively. In this case, the first advertising information output unit 55 extracts, for example, the “advertising information Yc” with the advertisement ID “O3” from the advertising information table.

Assume, for example, a further case in which a frequency of visit by the entry user U to a store of the partner company CB as identified from the purchase history of the user information is equal to, or greater than, a predetermined value. In this case, the first advertising information output unit 55 extracts, for example, the “advertising information Yd” with the advertisement ID “O4” from the advertising information table.

Assume, for example, a still further case in which the user information notified from the user information extracting unit 54 represents all user information on the partner company C corresponding to the site which the entry user U has entered, or user information on the store which the entry user U has entered. In this case, the first advertising information output unit 55 extracts advertising information from the advertising information table based on these pieces of user information.

For example, the first advertising information output unit 55 determines business status of the partner company C from the user information extracted by the user information extracting unit 54 and extracts, from the advertising information table, advertising information related to the business status thus determined. The business status of the partner company C determined by the first advertising information output unit 55 includes, for example, a category of business of the partner company C, and types, details, and volumes of commodities and services provided by the partner company C.

In this manner, the first advertising information output unit 55 can select advertising information based on the user information on the partner company C. The delivery of the advertisement can thereby be targeted at the user U related to the partner company C, which enables targeted advertising with high accuracy.

After having output the advertising information, the first advertising information output unit 55 sets an advertisement delivery history that includes information indicating the output advertising information (e.g., an advertisement ID) in an advertisement delivery history table. FIG. 11 is a diagram illustrating an exemplary advertisement delivery history table.

As illustrated in FIG. 11, the advertisement delivery history table includes information on “delivered advertisement”, “delivered store”, and “delivery date and time of day” associated with “terminal ID”. The “delivered advertisement” is the advertisement ID of the output advertising information. The “delivered store” is the store ID of the store that has triggered the advertisement delivery as a result of entry of the wireless terminal 5. The “delivery date and time of day” represents the time of day at which the first advertising information is output by the first advertising information output unit 55.

2.2.7 User Behavior Determining Unit 56

The user behavior determining unit 56 determines, based on the entry information and the behavior history information, behavior of the user U having the wireless terminal 5 to which the first advertising information has been delivered by the first advertising information output unit 55.

Specifically, the user behavior determining unit 56 identifies, based on the advertisement delivery history table, the wireless terminal 5 to which the first advertising information has been output by the first advertising information output unit 55 to be an object to which the second advertising information is to be delivered (hereinafter also referred to as a delivery destination terminal).

The user behavior determining unit 56 determines behavior of the user U having the wireless terminal 5 identified as the delivery destination terminal (hereinafter also referred to as a delivery destination user U) and stores behavior information associated with the behavior of the delivery destination user U in the user behavior history DB 44.

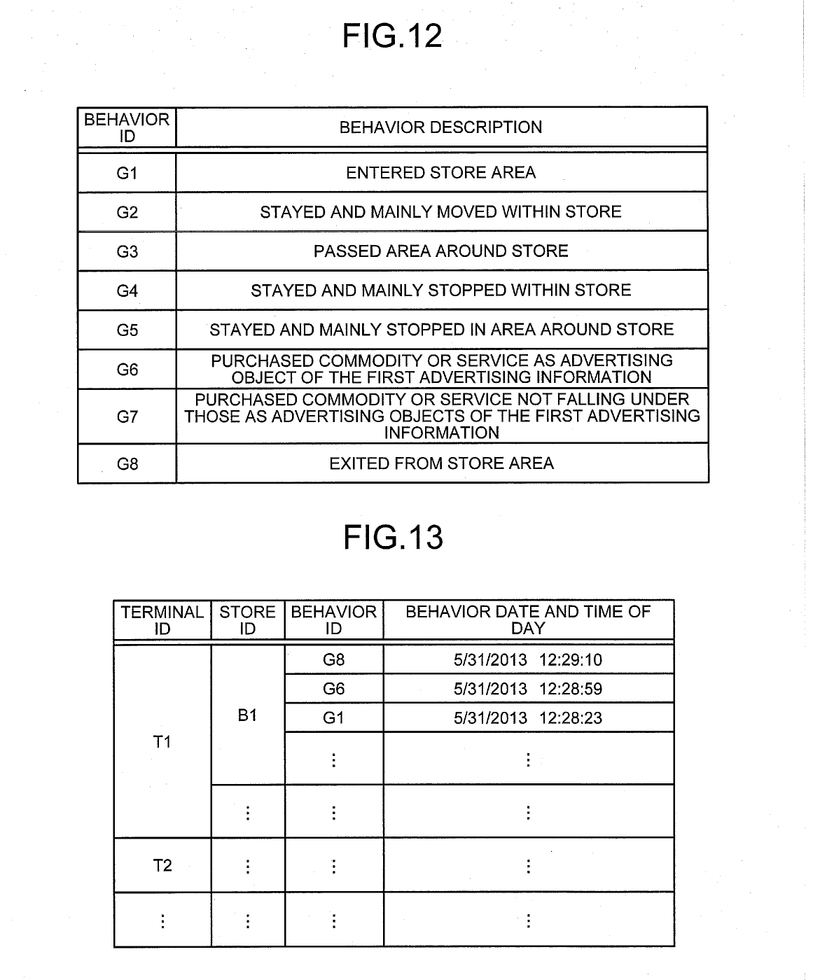

The behavior of the delivery destination user U is determined based on a behavior determining table stored in the user behavior history DB 44. FIG. 12 is a diagram illustrating an exemplary behavior determining table. As illustrated in FIG. 12, the behavior determining table includes information on “behavior description” associated with “behavior ID”. The “behavior ID” is identification information assigned to the behavior the delivery destination user U performs. The “behavior description” describes the behavior the delivery destination user U performs.

The first advertising information output unit 55 determines the moving state of the delivery destination user U in the store area based on the information set on the terminal detection table. Specifically, the first advertising information output unit 55 determines the behavior of the delivery destination user U based on a detection elapsed time and a change in the radio wave strength of the delivery destination terminal set in the terminal detection table. The detection elapsed time is a difference between the detection start time of day and the current time of day.

For example, if new entry information on a delivery destination terminal is set in the terminal detection table, the user behavior determining unit 56 determines entry in the store area and determines that the delivery destination user U has performed behavior corresponding to the behavior ID “G1”.

If the radio wave strength remains equal to, or greater than, a predetermined value continuously for a predetermined period of time or longer and the amount of change in the radio wave strength per predetermined period of time is relatively large, the user behavior determining unit 56 determines that the delivery destination user U has performed behavior corresponding to the behavior ID “G2”. If the radio wave strength is detected only for a short period of time, the radio wave strength falls below a predetermined value, and the amount of change in the radio wave strength per predetermined period of time is relatively large, the user behavior determining unit 56 determines that the delivery destination user U has performed behavior corresponding to the behavior ID “G3”.

If the radio wave strength remains equal to, or greater than, a predetermined value continuously for a predetermined period of time or longer and the amount of change in the radio wave strength per predetermined period of time is relatively small, the user behavior determining unit 56 determines that the delivery destination user U has performed behavior corresponding to the behavior ID “G4”. If the radio wave strength remains below a predetermined value continuously for a predetermined period of time and the amount of change in the radio wave strength per predetermined period of time is relatively small, the user behavior determining unit 56 determines that the delivery destination user U has performed behavior corresponding to the behavior ID “G5”.

In addition, the user behavior determining unit 56 determines the commodity or service purchase status of the delivery destination user U in the store area based on the partner company's user information table. The user behavior determining unit 56 further determines whether the commodity or service the delivery destination user U has purchased is among the commodities or services as the advertising objects of the first advertising information.

If the commodity or service the delivery destination user U has purchased is among the commodities or services as the advertising objects of the first advertising information, the user behavior determining unit 56 determines that the delivery destination user U has performed behavior corresponding to the behavior ID “G6”. If the commodity or service the delivery destination user U has purchased is not among the commodities or services as the advertising objects of the first advertising information, the user behavior determining unit 56 determines that the delivery destination user U has performed behavior corresponding to the behavior ID “G7”.

Assume, for example, a case in which the partner company's user information table is as illustrated in FIG. 6 and the advertising information table is as illustrated in FIG. 7. In this case, the advertising information Yc with the advertisement ID “O3” is delivered to the delivery destination user U at the store B₁ with the store ID “B1”, the advertising object of the advertising information Yc is coffee Ha produced by company H, and the delivery destination user U purchases coffee Ha at the store B₁ as soon as the advertising information Yc is delivered thereto. Thus, the user behavior determining unit 56 determines that the delivery destination user U has performed behavior corresponding to the behavior ID “G6”.

When entry information on the delivery destination terminal is no longer set in the terminal detection table, the user behavior determining unit 56 determines an exit from the store area and determines that the delivery destination user U has performed behavior corresponding to the behavior ID “G8”.

The user behavior determining unit 56 sets the behavior ID corresponding to the determination made relative to the delivery destination user U in question in a behavior history table. FIG. 13 is a diagram illustrating an exemplary behavior history table. As illustrated in FIG. 13, the behavior history table is information on “store ID”, “behavior ID”, and “behavior date and time of day” associated with “terminal ID”.

The behavior determining table in FIG. 12 is illustrated by way of example and is not limiting. For example, the behavior determining table may include the behavior ID corresponding to the position of the delivery destination user U based on the radio wave strength and the behavior ID for a case in which a commodity or service purchased by the delivery destination user U is similar to a commodity or service among the advertising objects of the first advertising information.

As described above, the user behavior determining unit 56 can determine the behavior of the user U having the wireless terminal 5 based on the time period of stay and/or the moving state of the user U having the wireless terminal 5 at the entry site of the wireless terminal 5. The user behavior determining unit 56 can also determine the behavior of the user U having the wireless terminal 5 based on the commodity or service purchase history of the user U having the wireless terminal 5 at the entry site of the wireless terminal 5. Additionally, the user behavior determining unit 56 can detect entry in, and exit from, the store area of the wireless terminal 5.

2.2.8 Second Advertising Information Output Unit 57

The second advertising information output unit 57 extracts, as the second advertising information, the advertising information according to the behavior of the delivery destination user U from the advertisement DB 43 based on the behavior history table set by the user behavior determining unit 56 and outputs the second advertising information to the delivery destination terminal. The behavior of the delivery destination user U may be classified into two types, one performed in an identical store area and the other performed among different store areas. The following describes each of these two types of behavior in sequence.

Behavior Performed in an Identical Store Area

The behavior performed in an identical store area refers to that performed by the delivery destination user U in a first advertisement delivery store area after the first advertising information has been output to the delivery destination terminal. The first advertisement delivery store area serves as a trigger for outputting the first advertising information to the delivery destination terminal by the first advertising information output unit 55. It is noted that the second advertising information output unit 57 may limit the behavior performed in the identical store area to that performed during a period of time that begins with the output of the first advertising information to the delivery destination terminal and ends with the exit of the delivery destination terminal from the first advertisement delivery store area.

When the behavior IDs “G2” to “G5” are set on the behavior history table as the behavior of the delivery destination user U in the first advertisement delivery store area, the second advertising information output unit 57 extracts the second advertising information based on, for example, the number of behavior IDs “G2” and continuity of the behavior ID “G2”.

If the behavior ID “G2” is set on the behavior history table, the visit is, for example, likely to be to kill time by walking around in the store. In response to this, the second advertising information output unit 57 selects, as the second advertising information, for example, advertising information intended for visitors to come to the store for simply killing time. For example, the second advertising information output unit 57 provides the delivery destination user U with advertising information for commodities and services that sell well as the second advertising information.

If the behavior ID “G3” is set on the behavior history table, the delivery destination user U is likely to be a potential customer who passes by an area around the store corresponding to the first advertisement delivery store area. In response to this, the second advertising information output unit 57 provides the delivery destination user U with, for example, advertising information that can motivate visit to the store as the second advertising information.

The second advertising information that can motivate the visit has, as the advertising object, a commodity or service that is, for example, neither identical, nor related, to the commodity or service as the advertising object of the first advertising information. Providing the delivery destination user U having no interest in the first advertising information with advertising information different from the first advertising information can increase the possibility of his/her visit to the store corresponding to the first advertisement delivery store area.

The second advertising information output unit 57 may make the second advertising information that can motivate the visit identical to the first advertising information. Providing the delivery destination user U with the same advertising information repeatedly can increase the possibility of his/her visit to the store corresponding to the first advertisement delivery store area.

If the behavior ID “G4” is set on the behavior history table, the delivery destination user U is likely to hesitate over purchasing the commodity or service. In response to this, the second advertising information output unit 57 selects, as the second advertising information, for example, advertising information that is more profitable for the delivery destination user U than the first advertising information. For example, if the first advertising information is a coupon, the second advertising information output unit 57 provides the delivery destination user U with another coupon offering a greater discount rate as the second advertising information.

If the behavior ID “G5” is set on the behavior history table, the delivery destination user U is likely to wait for someone to come or be absorbed in talking to someone at an area around the store corresponding to the first advertisement delivery store area. In response to this, the second advertising information output unit 57 provides the delivery destination user U with a coupon for coffee or ice cream as the second advertising information.

If, for example, the behavior ID “G6” is set on the behavior history table as the behavior of the delivery destination user U in the first advertisement delivery store area, the second advertising information output unit 57 extracts, from the advertisement DB 43, the second advertising information related to the first advertising information and outputs the second advertising information to the delivery destination terminal. The second advertising information related to the first advertising information refers to, for example, the advertising information having as the advertising object the commodity or service identical or related to the commodity or service as the advertising object of the first advertising information. For example, if the first advertising information is “coffee Ha produced by company H”, then a coupon for “coffee Ha produced by company H” is the second advertising information. The second advertising information may alternatively be the advertising information intended for, for example, a commodity such as tobacco or chocolate that is enjoyed favorably with coffee.

If, for example, the behavior ID “G7” is set on the behavior history table as the behavior of the delivery destination user U in the first advertisement delivery store area, the second advertising information output unit 57 extracts, for example, from the advertisement DB 43, the second advertising information not related to the first advertising information and outputs the second advertising information to the delivery destination terminal.

The second advertising information not related to the first advertising information is advertising information that has, as the advertising object, for example, a commodity or service that is neither identical, nor related, to the commodity or service as the advertising object of the first advertising information. With the behavior ID “G7” set, the second advertising information output unit 57 may still extract, as the second advertising information, from the advertisement DB 43, the advertising information that has, as the advertising object, the commodity or service identical or related to the commodity or service purchased by the delivery destination user U.

If it is determined that a commodity or service that is, although different from the commodity or service of the advertiser as the advertising object of the first advertising information, of an identical type priced lower is to be purchased, the second advertising information output unit 57 may even extract, as the second advertising information, from the advertisement DB 43, a coupon that provides the commodity or service as the advertising object of the first advertising information at a lower price.

In summary, the second advertising information output unit 57 provides the delivery destination terminal with, as the second advertising information, the advertising information on a type according to the time period of stay or the moving state of the delivery destination user U in the store and the advertising information on a type according to the commodity or service purchased by the delivery destination user U in the store. This enables targeted advertising with high accuracy.

Additionally, a table that associates the behavior ID with the type of the second advertising information (hereinafter, a behavior-advertisement correlation table) is set for each company ID or store ID in the advertisement DB 43. The behavior-advertisement correlation table may be set for, for example, each time period, day of the week, and season in the advertisement DB 43. In this case, the second advertising information output unit 57 extracts the second advertising information from the advertisement DB 43 based on the behavior-advertisement correlation table according to, for example, the partner company C, the store, the time period, the day of the week, and the season.

The second advertising information output unit 57 sets the advertising information related to the first advertising information as the second advertising information. This enables effective retargeted advertising, which in turn leads to targeted advertising with high accuracy.

Behavior Performed Among Different Store Areas

When the delivery destination user U enters the store area of a store of the same company but different from the store of the company corresponding to the first advertisement delivery store area, the second advertising information output unit 57 provides the delivery destination user U, as the second advertising information, advertising information corresponding to the behavior of the delivery destination user U in the first advertisement delivery store area.

Assume, for example, a case in which the delivery destination user U enters the store area of the store B₁ of the partner company CB and then enters the store area of the store B₂. In this case, the second advertising information output unit 57 provides the delivery destination user U, as the second advertising information, the advertising information corresponding to the behavior of the delivery destination user U in the store area of the store B₁.

Suppose that the store B₁ is a grilled meat restaurant and the store B₂ is a convenience store. If the delivery destination user U first eats grilled meat at the store B₁ and then, within a predetermined period of time, enters the store area of the store B₂, then the second advertising information output unit 57 outputs a coupon for ice cream or coffee, for example, to the delivery destination terminal as the second advertising information.

Alternatively, suppose that the store B₁ and the store B₂ are convenience stores. If the delivery destination user U is determined to be the behavior ID “G2” or “G4” without purchasing any commodities at the store B₁, the second advertising information output unit 57 outputs, as soon as the delivery destination user U enters the store area of the store B₂, a coupon to be used at a restaurant located ahead of the store B₂ as the second advertising information to the delivery destination terminal.

Still alternatively, suppose that the store B₁ and the store B₂ fall under an identical category of business and the first advertising information is output to the delivery destination terminal in the store area of the store B₁. In this case, if the delivery destination user U enters the store area of the store B₂ within a predetermined period of time, the second advertising information output unit 57 provides the delivery destination user U, as the second advertising information, the same advertising information as the first advertising information. Providing the delivery destination user U with the same advertising information repeatedly allows awareness of the commodity or service by the delivery destination user U to be enhanced through the advertising information, so that possibility of his/her visit to the store B₁ or the store B₂ can be enhanced.

In summary, the second advertising information output unit 57 provides the delivery destination user U with, as the second advertising information, the advertising information according to the behavior of the delivery destination user U performed among different store areas of the same company. This enhances an advertising effect by the second advertising information to thereby achieve targeted advertising with high accuracy. Additionally, the second advertising information output unit 57 can vary the second advertising information according to each of a time period, a day of the week, and a season. This further enhances the advertising effect by the second advertising information.

3. Process Procedure Performed by Advertisement Delivery System 1

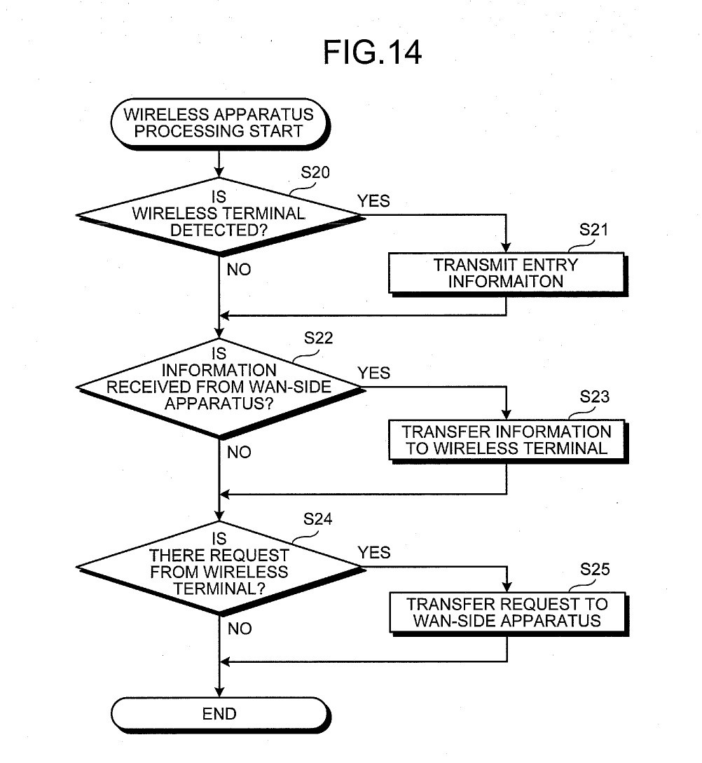

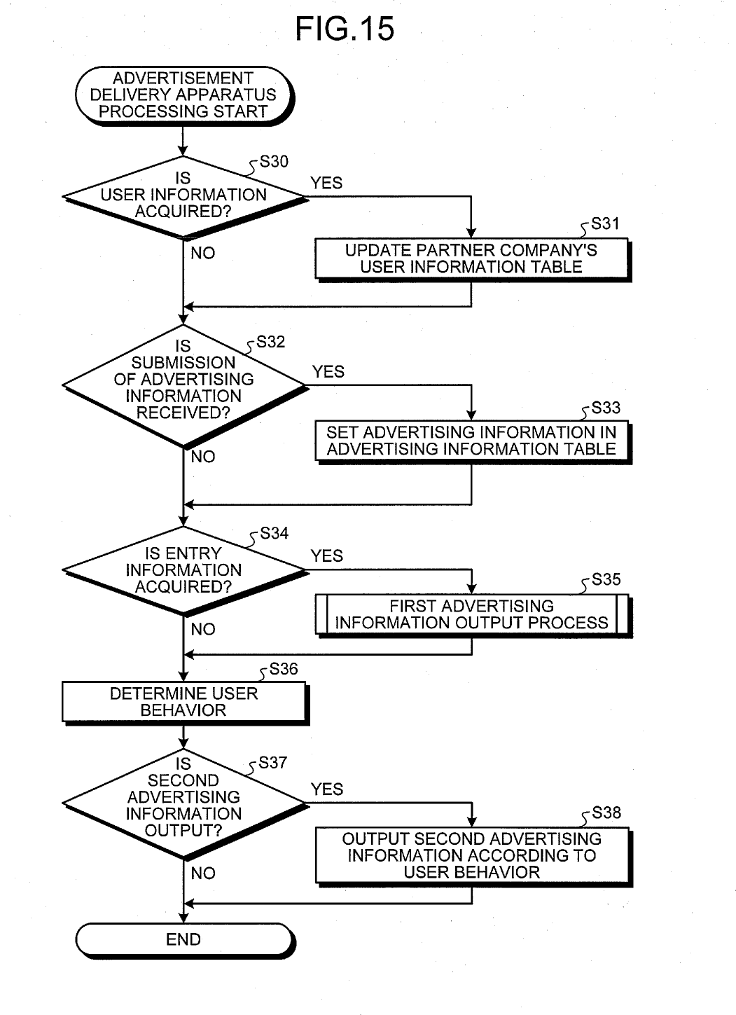

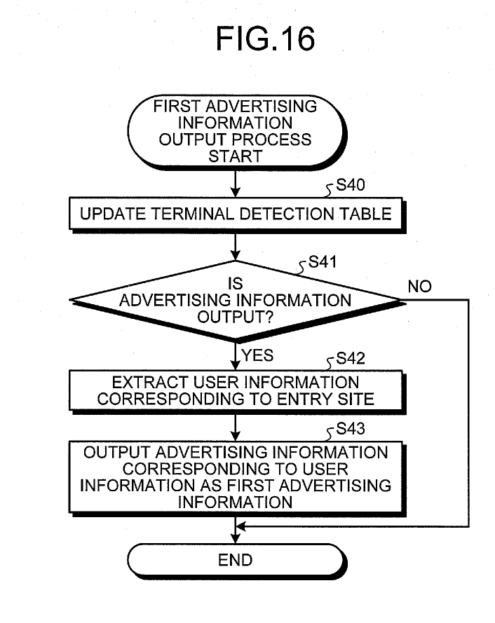

The following describes the procedure of an information providing process performed by the advertisement delivery system 1 according to the embodiment. FIGS. 14 to 16 are flowcharts for illustrating the procedure of the information providing process performed by the advertisement delivery system 1. In the following, information processing performed by the wireless apparatus 6 will be described with reference to FIG. 14 and information processing performed by the advertisement delivery apparatus 3 will be described with reference to FIGS. 15 and 16.

Processing Performed by the Wireless Apparatus 6

The information processing performed by the wireless apparatus 6 according to the embodiment will first be described. FIG. 14 is a flowchart illustrating information processing performed by the wireless apparatus 6 according to the embodiment. The operations are repeatedly performed by the control unit 23 of the wireless apparatus 6.

As illustrated in FIG. 14, the control unit 23 of the wireless apparatus 6 determines whether the wireless terminal 5 is detected (Step S20). If it is determined at this step that the wireless terminal 5 is detected (Yes at Step S20), the entry information is transmitted to the advertisement delivery apparatus 3 via the WAN communication unit 22 (Step S21).

If it is determined at Step S20 that the wireless terminal 5 is not detected (No at Step S20), or if the process at Step S21 is terminated, the control unit 23 determines whether information is received via the WAN communication unit 22 from a WAN-side apparatus connected to the communication network 7 (Step S22). The WAN-side apparatus may, for example, be the advertisement delivery apparatus 3 and the server 8. If it is determined that the information is received from the WAN-side apparatus (Yes at Step S22), the control unit 23 transfers the received information to the wireless terminal 5 as the destination of this information (Step S23).

If it is determined at Step S22 that the information is not received (No at Step S22), or if the process at Step S23 is terminated, the control unit 23 determines whether there is a request made from the wireless terminal 5 to the WAN-side apparatus (Step S24). If it is determined that there is a request made from the wireless terminal 5 to the WAN-side apparatus (Yes at Step S24), the control unit 23 transfers, to the WAN-side apparatus via the WAN communication unit 22, the request from the wireless terminal 5 to the WAN-side apparatus (Step S25).

If the process at Step S25 is terminated, or it is determined at Step S24 that there is no request made from the wireless terminal 5 to the WAN-side apparatus (No at Step S24), the control unit 23 terminates the process.

Processing Performed by the Advertisement Delivery Apparatus 3

The following describes the information processing performed by the advertisement delivery apparatus 3 according to the embodiment. FIG. 15 is a flowchart illustrating the information processing performed by the advertisement delivery apparatus 3 according to the embodiment. The operations are repeatedly performed by the control unit 32 of the advertisement delivery apparatus 3.

As illustrated in FIG. 15, the control unit 32 determines whether the user information on the partner company C is acquired from the information management apparatus 2 via the communication unit 30 (Step S30). If it is determined that the user information on the partner company C is acquired (Yes at Step S30), the control unit 32 sets the acquired user information on the partner company's user information table of the partner information DB 41 to thereby update the partner company's user information table (Step S31).

If it is determined at Step S30 that the user information on the partner company C is not acquired (No at Step S30), or if the process at Step S31 is terminated, then the control unit 32 determines whether submission of the advertising information is received from an advertiser's apparatus via the communication unit 30 (Step S32). If it is determined that the submission of the advertising information is received (Yes at Step S32), the control unit 32 sets the received advertising information in the advertising information table of the advertisement DB 43 (Step S33).

If it is determined that the submission of the advertising information is not received (No at Step S32), or if the process at Step S33 is terminated, then the control unit 32 determines whether the entry information transmitted from the wireless apparatus 6 via the communication unit 30 is acquired (Step S34). If it is determined that the entry information is acquired (Yes at Step S34), the control unit 32 performs a first advertising information output process (Step S35). The first advertising information output process represents the process of Steps S40 to S43 illustrated in FIG. 16 and will be described in detail later.

If it is determined that the entry information is not acquired (No at Step S34), or if the process at Step S35 is terminated, then the control unit 32 determines the behavior of the user U having the wireless terminal 5 to which the first advertising information has been output (Step S34). The control unit 32 determines, based on the behavior of the user U determined at Step S36, whether to output the second advertising information to the wireless terminal 5 to which the first advertising information has been output (Step S37).

Upon determining to output the second advertising information at Step S37 (Yes at Step S37), the control unit 32 extracts, from the advertisement DB 43, the advertising information corresponding to the behavior of the user U determined at Step S36. The control unit 32 outputs, as the second advertising information, the extracted advertising information to the wireless terminal 5 to which the first advertising information has been output (Step S38).

If it is determined not to output the second advertising information at Step S37 (No at Step S37), or if the process at Step S38 is terminated, the control unit 32 terminates the process.

The following describes the first advertising information output process at Step S35. FIG. 16 is a flowchart illustrating information processing performed in the first advertising information output process.

As illustrated in FIG. 16, at the start of the first advertising information output process, the control unit 32 updates the terminal detection table based on the entry information that is determined to have been acquired at Step S34 (Step S40). The control unit 32 determines whether to output the advertising information to the wireless terminal 5 that has entered the site corresponding to the partner company C (Step S41).

Upon determining to output the advertising information (Yes at Step S41), the control unit 32 extracts, from the partner information DB 41, the user information corresponding to the entry site of the wireless terminal 5 (Step S42). Next, the control unit 32 extracts, from the advertisement DB 43, the advertising information corresponding to the extracted user information and outputs the first advertising information to the wireless terminal 5 that has entered the site corresponding to the partner company C (Step S43).

If it is determined not to output the advertising information at Step S41 (No at Step S41), or if the process at Step S43 is terminated, the control unit 32 terminates the process.

### 4. Other Embodiments

The embodiment described above detects entry in the site corresponding to the partner company C using the wireless apparatus 6. Instead, the advertisement delivery apparatus 3 can detect the entry of the wireless apparatus 6 in the site corresponding to the partner company C based on information from the wireless terminal 5.

If, for example, the wireless terminal 5 has a GPS function, the entry information acquiring unit 52 detects the entry of the wireless terminal 5 in the site corresponding to the partner company C based on latitude and longitude information transmitted from the wireless terminal 5. In this case, position range information that associates information indicating an entry detection range with the store ID is stored in the entry information DB 42 in advance. The entry information acquiring unit 52 extracts, from the position range information, the store ID corresponding to the entry detection range including the latitude and the longitude of the wireless terminal 5 based on the latitude and longitude information transmitted from the wireless terminal 5.

If the entry information including the company ID and the store ID is transmitted from the wireless terminal 5, the control unit 32 of the advertisement delivery apparatus 3 may detect the entry of the wireless terminal 5 in the site corresponding to the partner company C based on the entry information from the wireless terminal 5. In this case, the wireless terminal 5 includes a storage that stores therein information that associates the position information on the “site corresponding to the partner company C” with the company ID and the store ID. The control unit of the wireless terminal 5 compares, based on the information stored in the storage, the position information on the “site corresponding to the partner company C” with the latitude and the longitude of the current position to thereby detect the company ID and the store ID of the entry site. The control unit of the wireless terminal 5 then transmits the entry information including the company ID and the store ID to the advertisement delivery apparatus 3.

The advertisement determining unit 53 may still determine the type of entry state of the user U, such as staying in the store, and passing by or walking around the area outside the store, according to the time period of stay in the AP communication area and the radio wave strength. The information extraction instruction output in this case from the advertisement determining unit 53 includes entry state information. The entry state information indicates the type of the entry state. The first advertising information output unit 55 can select the advertising information based on the entry state information notified from the advertisement determining unit 53. For example, the first advertising, information output unit 55 may select advertising information that specifies as the delivery condition the “time period of stay in the store”, “passing by the area around the store”, or “walking around the area outside the store” based on the entry state information.

In addition, the first advertising information output unit 55 and the second advertising information output unit 57 may opt not to output, for a predetermined period of time after the advertising information was output from the advertisement delivery apparatus 3 to a wireless terminal 5, the advertising information to the same wireless terminal 5. In this case, the advertisement delivery apparatus 3 outputs the second advertising information preferentially over the first advertising information.

In the embodiment, the user behavior determining unit 56 determines the behavior of the user U within a single store area. Instead, the user behavior determining unit 56 may determine the behavior of the user U within a plurality of store areas.

Additionally, the user behavior determining unit 56 may determine the behavior of the user U based on information on a web page posted by the user U (hereinafter, a user page). The user page may, for example, be a mini-blog page or a social networking service (SNS) page. The user information acquiring unit 50, for example, acquires user page information from the server 8 and stores the information in the user behavior history DB 44. The user behavior determining unit 56 determines the behavior of the user U based on the user page information stored in the user behavior history DB 44.

### 5. Hardware Configuration

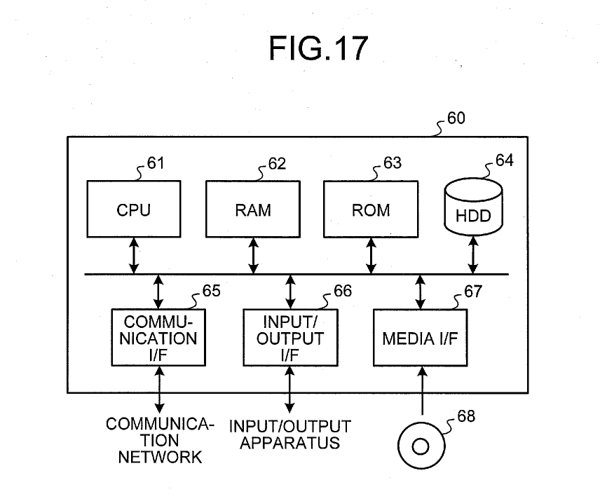

The information management apparatus 2 according to the embodiment may be achieved by a computer 60 configured, for example, as illustrated in FIG. 17. FIG. 17 is a hardware configuration diagram of an exemplary computer that achieves the functions of the information management apparatus 2. The computer 60 includes a central processing unit (CPU) 61, a random access memory (RAM) 62, a read only memory (ROM) 63, a hard disk drive (HDD) 64, a communication interface (I/F) 65, an input/output interface (I/F) 66, and a media interface (I/F) 67.

The CPU 61 operates based on a computer program stored in the ROM 63 or the HDD 64 to thereby control different elements. The ROM 63 stores therein, for example, a boot program executed by the CPU 61 during the start of the computer 60 and a computer program dependent on the hardware of the computer 60.

The HDD 64 stores therein, for example, a computer program executed by the CPU 61 and data used by the program. The communication I/F 65 corresponds to the communication unit 30. The communication I/F 65 receives data from other devices and sends the data to the CPU 61 over the communication network 7, and transmits data generated by the CPU 61 to other devices over the communication network 7.

The CPU 61 controls output devices such as a display and a printer and input devices such as a keyboard and a mouse via the input/output I/F 66. The CPU 61 acquires data from the input devices via the input/output I/F 66. The CPU 61 transmits generated data to the output devices via the input/output I/F 66.

The media I/F 67 reads a computer program or data stored in a recording medium 68 and provides the CPU 61 with the program or data via the RAM 62. The CPU 61 loads the program on the RAM 62 from the recording medium 68 via the media I/F 67 and executes the loaded program. The recording medium 68 is, for example, an optical recording medium such as a digital versatile disc (DVD) and a phase change rewritable disk (PD), a magneto-optical recording medium such as a magneto-optical disk (MO), a tape medium, a magnetic recording medium, or a semiconductor memory.

To cause the computer 60 to function as the information management apparatus 2, the CPU 61 of the computer 60 executes the program loaded on the RAM 62 to thereby achieve the functions of the user information acquiring unit 50, the advertising information acquiring unit 51, the entry information acquiring unit 52, the advertisement determining unit 53, the user information extracting unit 54, the first advertising information output unit 55, the user behavior determining unit 56, and the second advertising information output unit 57. Additionally, the HDD 64 achieves the function of the storage unit 31 and stores therein, for example, the partner company's user information table, the advertising information table, the terminal detection table, the partner company information table, the correspondence information table, the advertisement delivery history table, the behavior determining table, and the behavior history table.

The CPU 61 of the computer 60 loads these programs from the recording medium 68. Alternatively, the CPU 61 may acquire these programs from other devices over the communication network 7.

### 6. Effects

The advertisement delivery apparatus 3 of the advertisement delivery system 1 according to the present embodiment includes the partner information DB 41 (an exemplary company information DB), the entry information acquiring unit 52, the user information extracting unit 54, the first advertising information output unit 55, and the second advertising information output unit 57. The partner information DB 41 stores therein the user information on the partner company C (an exemplary company). The entry information acquiring unit 52 acquires, as the entry information, information on the site corresponding to the partner company C and information on the wireless terminal that has entered the site corresponding to the partner company C. The user information extracting unit 54 extracts, from the partner information DB 41, user information on the partner company C corresponding to the entry site of the wireless terminal 5 based on the entry information. The first advertising information output unit 55 outputs the first advertising information corresponding to the user information extracted by the user information extracting unit 54 to the wireless terminal 5 that has entered the site corresponding to the partner company C. The second advertising information output unit 57 outputs, to the wireless terminal 5, the second advertising information corresponding to the behavior of the user U having the wireless terminal 5 after the output of the first advertising information.

In this manner, the advertisement delivery apparatus 3 provides the second advertising information based on the behavior of the entry user U after the first advertising information related to the partner company C has been provided for the wireless terminal 5 of the entry user U. This enables the purchase of commodities and services to be promoted more effectively and with higher accuracy.

The advertisement delivery apparatus 3 includes the user behavior determining unit 56 that determines the behavior of the user U having the wireless terminal 5 in the entry site after the first advertising information has been output. The second advertising information output unit 57 outputs, as the second advertising information, to the wireless terminal 5, the advertising information corresponding to the behavior of the user U having the wireless terminal 5 determined by the user behavior determining unit 56.

This enables the advertisement delivery apparatus 3 to determine the behavior of the user U having the wireless terminal 5, so that the second advertising information can be promptly output from the second advertising information output unit 57 to the wireless terminal 5.

The user behavior determining unit 56 determines the behavior of the user U having the wireless terminal 5 based on the time period of stay and/or the moving state of the user U having the wireless terminal 5 at the entry site of the wireless terminal 5.

This enables, for example, the behavior of the user U having the wireless terminal 5 to be determined based on the entry information transmitted from the wireless apparatus 6, facilitating collection of information for determining the behavior of the user U.

The user behavior determining unit 56 determines the behavior of the user U having the wireless terminal 5 based on the history of the commodity or the service which the user U having the wireless terminal 5 purchases in the entry site of the wireless terminal 5.

If, for example, the entry user U₁ purchases a commodity or service as the advertising object of the first advertising information at the store B₁, the foregoing arrangement allows the advertisement delivery apparatus 3 to provide the wireless terminal 5₁ with a coupon for the purchased commodity or service as the second advertising information. This can motivate the entry user U₁ to purchase the purchased commodity or service repeatedly.

If the wireless terminal 5 to which the first advertising information has been output enters a site different from a past entry site among sites corresponding to the partner company C, the second advertising information output unit 57 outputs, as the second advertising information, advertising information corresponding to the entry of the wireless terminal 5 in the different site.

This enables the advertising information corresponding to the behavior of the delivery destination user U among different store areas of the same company to be provided as the second advertising information for the delivery destination user U. This enhances an advertising effect by the second advertising information.

The entry information acquiring unit 52 acquires entry information from the wireless apparatus 6 (an exemplary wireless LAN access point) having the site corresponding to the partner company C as the wireless communication area.

With a wireless LAN access point installed in the site corresponding to the partner company C, the foregoing arrangement allows entry of the wireless terminal 5 in the site corresponding to the partner company C to be detected without the need for any other wireless apparatus.

The first advertising information output unit 55 outputs the advertising information to the wireless terminal 5 that has entered the site corresponding to the partner company C when the time period of stay of the wireless terminal 5 within the communication area of the wireless apparatus 6 and/or the radio wave strength of the wireless terminal 5 acquired by the wireless apparatus 6 satisfy a predetermined condition.

This allows a specific object to which the advertising information is to be output to be targeted, as selected out of the wireless terminals 5 that have entered the site corresponding to the partner company C. The foregoing arrangement further excludes the wireless terminal 5 that stays in the communication area of the wireless apparatus 6 only for a short period of time and that is not very much related to the site corresponding to the partner company C.

The advertisement delivery apparatus 3 includes the user information acquiring unit 50 that acquires user information owned by each of a plurality of partner companies C. The partner information DB 41 stores therein the user information on the partner companies C acquired by the user information acquiring unit 50.

This allows the user information on the partner companies C to be provided, so that the advertising information can be targeted at the user U of a specific one of the partner companies C. The purchase of commodities and services can thereby be promoted effectively and with high accuracy.

### 7. Miscellaneous

Some embodiments of the present application have been described in detail with reference to the accompanying drawings. These embodiments are only illustrative and are not intended to limit the present invention. It is understood that changes and modifications may be made without departing from the spirit and scope the present invention.

The advertisement delivery apparatus 3 may be achieved by a plurality of server computers. The configuration of the advertisement delivery apparatus 3 can also be flexibly changed, including achieving some of its functions by calling an external platform using an application programming interface (API) or network computing, for example.

An embodiment of the present invention can provide an advertisement delivery apparatus, an advertisement delivery method, and an advertisement delivery program enabling targeted advertising with high accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery apparatus comprising:
a company information database configured to store therein user information on a company;
an entry information acquiring unit configured to acquire entry information including information on a wireless terminal when the wireless terminal enters a site corresponding to the company;
a user information extracting unit configured to extract, from the company information database, the user information on the company corresponding to an entry site of the wireless terminal based on the entry information;
a first advertising information output unit configured to output first advertising information corresponding to the user information extracted by the user information extracting unit to the wireless terminal; and
a second advertising information output unit configured to output, to the wireless terminal, second advertising information corresponding to behavior of a user having the wireless terminal after the output of the first advertising information.

2. The advertisement delivery apparatus according to claim 1, further comprising:
a user behavior determining unit configured to determine behavior of the user having the wireless terminal in the entry site after the output of the first advertising information, wherein
the second advertising information output unit outputs, to the wireless terminal, advertising information, as the second advertising information, corresponding to the behavior of the user having the wireless terminal determined by the user behavior determining unit.

3. The advertisement delivery apparatus according to claim 2, wherein the user behavior determining unit determines the behavior of the user having the wireless terminal based on a time period of stay and/or a moving state of the user having the wireless terminal in the entry site of the wireless terminal.

4. The advertisement delivery apparatus according to claim 2, wherein the user behavior determining unit determines the behavior of the user having the wireless terminal based on a history of a commodity or service which the user having the wireless terminal purchases in the entry site of the wireless terminal.

5. The advertisement delivery apparatus according to claim 1, wherein when the wireless terminal to which the first advertising information is output enters a site different from the entry site among sites corresponding to the company, the second advertising information output unit outputs, as the second advertising information, advertising information corresponding to the entry of the wireless terminal in the different site.

6. The advertisement delivery apparatus according to claim 1, wherein the entry information acquiring unit acquires the entry information from a wireless LAN access point having the site corresponding to the company as a wireless communication area.

7. The advertisement delivery apparatus according to claim 6, wherein, when a time period of stay of the wireless terminal within the communication area of the wireless LAN access point and/or radio wave strength of the wireless terminal acquired at the wireless LAN access point satisfy a predetermined condition, the first advertising information output unit outputs the first advertising information to the wireless terminal.

8. The advertisement delivery apparatus according to claim 1, further comprising:
a user information acquiring unit that acquires the user information owned by each of a plurality of companies, wherein
the company information database stores therein user information on the companies acquired by the user information acquiring unit.

9. An advertisement delivery method implemented by a computer, the advertisement delivery method comprising:
acquiring entry information including information on a wireless terminal when the wireless terminal enters a site corresponding to a company;
extracting, from a company information database that stores therein user information on a company, the user information on the company corresponding to an entry site of the wireless terminal based on the entry information;
outputting first advertising information corresponding to the extracted user information to the wireless terminal; and
outputting, to the wireless terminal, second advertising information corresponding to behavior of a user having the wireless terminal after the outputting of the first advertising information.

10. The advertisement delivery method according to claim further comprising:
determining behavior of the user having the wireless terminal in the entry site after the output of the first advertising information, wherein
the outputting the first advertising information includes outputting, to the wireless terminal, advertising information, as the second advertising information, corresponding to the behavior of the user having the determined wireless terminal at the determining.

11. The advertisement delivery method according to claim 10, wherein the determining includes determining the behavior of the user having the wireless terminal based on a time period of stay and/or a moving state of the user having the wireless terminal in the entry site of the wireless terminal.

12. The advertisement delivery method according to claim 10, wherein the determining includes determining the behavior of the user having the wireless terminal based on a history of a commodity or service which the user having the wireless terminal purchases in the entry site of the wireless terminal.

13. The advertisement delivery method according to claim 9, wherein, the outputting the second advertising information includes outputting, when the wireless terminal to which the first advertising information is output enters a site different from the entry site among sites corresponding to the company, as the second advertising information, advertising information corresponding to the entry of the wireless terminal in the different site.

14. The advertisement delivery method according to claim 9, wherein the acquiring includes acquiring the entry information from a wireless LAN access point having the site corresponding to the company as a wireless communication area.

15. The advertisement delivery method according to claim 14, wherein, the outputting the first advertising information includes outputting the first advertising information to the wireless terminal when a time period of stay of the wireless terminal within the communication area of the wireless LAN access point and/or radio wave strength of the wireless terminal acquired at the wireless LAN access point satisfy a predetermined condition.

16. The advertisement delivery method according to claim 9, further comprising:
acquiring user information owned by each of a plurality of companies, and
storing the acquired user information on the companies at the acquiring the user information in the company information database.

17. A non-transitory computer readable storage medium containing program instructions for delivering adverting information, wherein execution of the program instructions by one or more processors of a computer system causes the one or more processors to perform:
acquiring entry information including information on a wireless terminal when the wireless terminal enters a site corresponding to a company;
extracting, from a company information database that stores therein user information on a company, the user information on the company corresponding to an entry site of the wireless terminal based on the entry information;
outputting first advertising information corresponding to the extracted user information to the wireless terminal; and
outputting, to the wireless terminal, second advertising information corresponding to behavior of a user having the wireless terminal after the outputting of the first advertising information.
